(19) United States
(12) Patent Application Publication
(10) Pub. No.: US 2010/0277774 A1
(43) Pub. Date: Nov. 4, 2010

(54) IMAGE QUALITY INDICATOR RESPONSIVE TO IMAGE PROCESSING

(75) Inventors: James W. Reid, E. Rochester, NY (US); Chris W. Honsinger, Ontario, NY (US); Paul W. Jones, Churchville, NY (US)

Correspondence Address: LOUIS S. HORVATH, PLS, 252 Plymouth Ave. South, ROCHESTER, NY, 14608, US

(73) Assignee: Certifi Media Inc., Union Hill, NY (US)

(21) Appl. No.: 12/765,507

(22) Filed: Apr. 22, 2010

Related U.S. Application Data
(60) Provisional application No. 61/175,168, filed on May 4, 2009.

(51) Int. Cl. H04N 1/04; G06K 9/68

(52) U.S. Cl. 358/474; 382/220

(57) ABSTRACT

A method for processing scanned image data, executed at least in part by a computer system, obtains scanned image data, obtains a predetermined image quality profile that has one or more image quality requirement values, and generates processed image data by applying one or more image processing operations to the image data in accordance with a processing script. The method calculates image quality metrics from the processed image data and compares the calculated image quality metrics to the one or more image quality requirement values from the predetermined quality profile. Results of the image quality comparison are displayed.

### CROSS REFERENCE TO RELATED APPLICATIONS

Priority is claimed from U.S. Ser. No. 61/175168, provisionally filed on May 4, 2009, entitled “IMAGE QUALITY INDICATOR RESPONSIVE TO IMAGE PROCESSING”, in the names of Paul W. Jones et al., commonly assigned and incorporated herein by reference.

### FIELD OF THE INVENTION

The invention relates generally to the field of image processing systems, and in particular to image processing systems that use image processing scripts to process one or more images in batch and interactive modes and where a specified level of image quality is desired for processed images.

### BACKGROUND OF THE INVENTION

Governments of many countries are digitizing historical documents and providing the digital image documents on the Internet, as well as archiving the digitized documents for future use. Paper-based medical records are also being digitized to provide electronic access to medical professionals for more efficient, timely, and accurate diagnoses. Similar digitization efforts are ongoing in commercial and government sectors to provide digital representations of legal and financial documents.

Each of these applications uses digital scanning to convert a physical medium to a digitized electronic representation. In producing the digitized electronic representation, image processing is applied routinely to the original scanned image data. Such image processing typically performs enhancement tasks including, for example, sharpening, rotation, brightness and contrast adjustment, and cropping. Increasingly, image processing also includes algorithms that interpret the data automatically, such as optical character recognition (OCR), barcode recognition, face recognition, or text layout analysis, to provide meaningful information to various search engines.

The image processing algorithms that are applied to scanned data are typically chosen by the operator performing the scanning, and the algorithm parameters are chosen to make the image “look good” from the operator's point of view. However, choosing image processing algorithms based on subjective quality using a single display at a single resolution may not anticipate other applications with different display characteristics or resolution needs. Moreover, choosing image processing to produce images that “look good” may not lead to optimal results in automatic data interpretation, such as in OCR, because important information that is used by OCR algorithms may be lost during image processing.

The paper documents that are scanned are often old and brittle and may be deteriorating even further over time. Scanning such documents properly the first time is extremely important because repeated handling can lead to further deterioration. In addition, mistakes during scanning and image processing can be very costly in light of the huge volumes of documents that are being scanned. It is easy to generate a lot of bad data fairly quickly, and recovering from such mistakes can be expensive and time consuming.

In an effort to help achieve higher quality and more consistent scanned data, various industry and government groups are publishing recommendations for scanned image quality. One example of a published recommendation is: Steven Puglia, Jeffery Reed, and Erin Rhoads, “Technical Guidelines for Digitizing Archival Materials for Electronic Access: Creation of Production Master Files—Raster Images,” U.S. National Archives and Records Administration (NARA), June 2004. This document provides recommendations for image quality metrics that meet the needs of the archiving and cultural heritage communities. It includes recommended techniques for measuring basic quality attributes such as sharpness, tone scale, noise, and color, and also provides preferred values for at least some of the measured quality variables.

In general, the quality measurements specified in such publications are made using test targets. Test targets are special physical media that include content having various known or premeasured properties. Test targets serve as references so that the image quality attributes of scanned data can be measured accurately and precisely. There are various companies that offer software products that allow one to measure test targets for one or more of the quality metrics needed to follow these published image quality recommendations.

There are several limitations with currently available test targets and software that measure quality metrics of the scanned image data containing test targets. One limitation is that the software products typically require manual identification of one or more image regions containing test target content so that the desired quality metric or metrics can be measured. In some products, the calculation of each quality metric requires a separate manual intervention step, which is very labor intensive. Another limitation is that once all of the quality metrics have been calculated, it is then necessary to manually compare each metric against the desired value. Moreover, both the quality analysis and quality comparison steps must be repeated if the image processing steps are changed in any way, such as the addition/deletion of a step, changing the order of the steps, or changes in the processing parameters used in a step.

This overall quality analysis process quickly becomes burdensome in actual production workflows where there may be a need to evaluate the image quality for different combinations of image processing steps and the associated processing parameters. Moreover, it may also be necessary to evaluate the quality metrics against a plurality of image quality profiles if the scanned image data is intended to be used in different applications. Such evaluations can be very time consuming and laborious.

Therefore, there is a need to overcome these limitations and provide faster and more convenient methods and systems for the processing of images to meet a desired level of image quality.

### SUMMARY OF THE INVENTION

Broadly speaking, the invention relates to an image quality indicator, responsive to image processing steps, that provides feedback regarding the image quality associated with a change in the image processing steps or a change in a parameter within an image processing step. The quality feedback is provided in such a way that a quick determination can be made as to whether or not the image processing is sufficient to meet a predefined quality need.

In providing feedback as to whether or not the image processing is sufficient to meet a predefined quality need, the present invention includes one or more image quality profiles that represent the range of acceptable quality values for one or more image quality metrics; an image processing module to process image data using one or more image processing steps in accordance with a processing script; an image quality processor that performs an automated analysis of processed image data to produce one or more image quality metrics; and an image quality indicator responsive to the image processing indicating whether or not the processed image data meets the acceptable values of the quality metrics.

The invention can be implemented in numerous ways, including as a method, system, device, apparatus, graphical user interface, or computer readable medium.

Other aspects and advantages of the invention will become apparent from the following detailed description taken in conjunction with the accompanying drawings which illustrate, by way of example, the principles of the invention.

### ADVANTAGEOUS EFFECT OF THE INVENTION

It is an advantage of the method of the present invention that it allows a user to evaluate various combinations of image processing steps (and associated processing parameters) and image quality profiles in a fast and efficient manner through use of an image quality indicator.

These and other aspects, objects, features, and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 illustrates an example of a high volume scanning workflow.

FIG. 2 illustrates an embodiment of the present invention using an image processing script and an image quality profile to produce an image quality indicator.

FIG. 3A illustrates an example of a software application using the present invention that produces an image processing script.

FIG. 3B shows a detail window that provides further information on image quality results in one embodiment.

FIG. 4 illustrates an example of an image processing script represented as an XML file.

FIG. 5 illustrates an example of a software application using the present invention that produces an image quality profile.

FIG. 6 illustrates an image quality profile represented as an XML file.

FIG. 7 shows a scanning system in an integrated embodiment of the present invention.

FIG. 8 illustrates an example of an LCD touch panel on a scanner that uses the present invention.

### DETAILED DESCRIPTION OF THE INVENTION

In the disclosure that follows, elements not specifically shown or described may take various forms well known to those skilled in the art.

Embodiments of the present invention execute on one or more computers or dedicated image processors that execute stored instructions for processing image data. Various arrangements of computer and related processor hardware are contemplated, including networked processors, for example. Transfer of data between processors and to and from data storage and memory devices can be effected using various types of wired or wireless network transmission or other forms of data interface, such as using removable magnetic or optical media, for example.

Embodiments of the present invention are executed on a computer or other type of control logic processor, such as a networked computer or host, dedicated processor or microprocessor, or other logic control device that is capable of executing programmed instructions. It can be appreciated by those skilled in the image processing arts that embodiments of the present invention can execute on any of a number of control logic processor configurations and using any of a number of processors, including networked processors. With any type of computer or other control logic processor, computer-accessible memory storage is provided in some form. Longer term storage can be provided, for example, by optical and magnetic storage devices, such as hard drives and CD or DVD storage disks. Short-term memory storage is generally provided by electronic circuitry, using random-access memory (RAM) or other memory circuitry to provide temporary workspace during processing, data transfer, or display.

The invention is directed to forming a digital file from image data generated by digitization of an “original” from a physical medium or a physical scene. The physical media may, for example, include originals of any of various types of written, printed, or imaged records such as bank checks, X-ray film, photographic film, historical letters, scholarly papers, photographs, income tax forms, and book or periodical pages, for example. Physical scenes include any physical entity or entities, such as people, places, and objects, for example, that have been imaged onto an image capture device. Embodiments of the present invention encompass image data from any manner of digital image capture device. Some types of image capture devices pass physical media over one-dimensional (1-D) line sensors (such as a scanner) to construct a two-dimensional (2-D) image data representation. Other imaging devices use a 2-D sensor (such as a digital camera) to directly produce a 2-D image data representation of a physical media or scene. The image data may also include a sequence of digital images, such as those produced by a video camera, where each frame of the image sequence is treated as a separate image for the purpose of the present invention. Image data acquired by any of these means is referred to herein using the general term “scanned image data”.

A preferred embodiment of the present invention is directed toward high volume document scanning, which necessitates minimal user intervention while maintaining the highest possible image quality. It is in this environment wherein significant cost savings can be obtained by the practice of this invention. However, it is appreciated that the invention can be equally applied to low volume scanning as well.

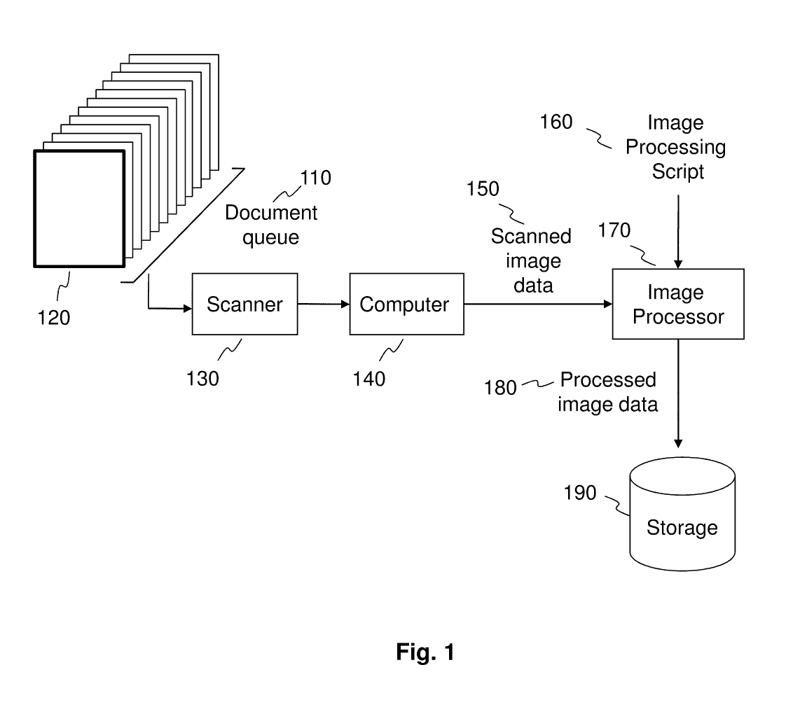

FIG. 1 depicts a high-volume scanning workflow according to one embodiment of the present invention. By definition, a high-volume scanning environment is one in which many documents are queued up to be scanned; these documents can be considered to reside in a document queue 110. The current document 120 from document queue 110 is scanned using a scanner 130. For purposes of illustration, scanner 130 may be a book scanner comprised of an automatic page turner and a camera that captures a single page at a time, the camera being synchronized to the page turner. Example book scanners are described in U.S. Pat. No. 7,509,087 to Lin and in U.S. Pat. No. 5,636,006 to Wu. When the scanner is a book scanner, individual documents within the document queue 110 correspond to the pages in a book.

Returning to FIG. 1, scanner 130 digitizes current document 120 to produce scanned image data, which is transferred to a computer 140. Generally, the acquired scanned image data 150 will be saved as a file into a directory in computer 140, where the directory is monitored for new files, i.e., a “hot” folder or directory. Once the scanned image data file is registered with the directory monitoring process, an image processing script 160, set up by the user or selected from a set of processing scripts created previously, is applied to scanned image data 150 using image processor 170, and processed image data 180 is saved to data storage 190. This process repeats, applied successively to each document in document queue 110.

Image processing script 160 is a set of instructions that describe how to perform image processing and thereby generate processed image data. Image processing script 160 includes a set of one or more image processing steps and associated processing parameters for each step. An image processing script can be very complex, specifying a sequence or combination of processing operations such as optical character recognition (OCR), geometric distortion removal, image compression, nonlinear enhancement, object detection, sharpening, smoothing, gamma correction, despeckle, blur, grayscale conversion, white balance adjustment, bordering, cropping, and noise cleaning, for example. However, an image processing script can be as simple as specifying that a single sharpening or resize operation is to be performed.

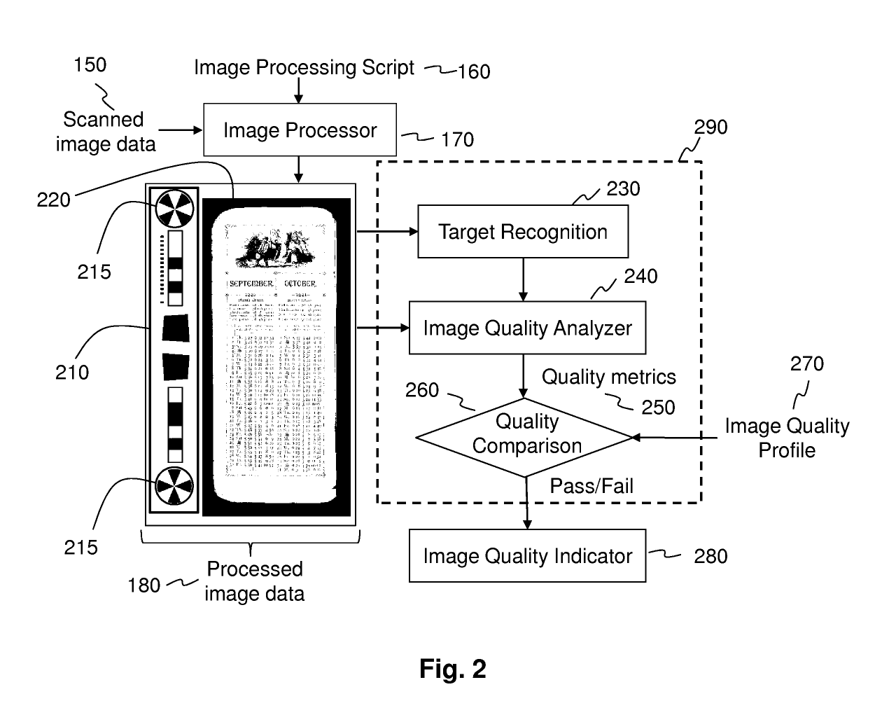

Referring to FIG. 2, an embodiment of the present invention is illustrated for processing a single scanned document page or other original. As previously described, image processor 170, a computer or other type of control logic processor, receives scanned image data 150 and image processing script 160 and produces processed image data 180. In the example shown in FIG. 2, the processed image data includes a composite of an image quality test target 210 and a page 220 from a 19^{th} century Farmer's Almanac.

Automated target recognition 230 is employed on the processed image data, using prior art techniques that may include the detection of fiducials, such as the two example fiducials 215 shown on the target 210 in FIG. 2. Target recognition means that each feature in the image quality test target 210 is located within the processed image data 180. Knowing the location of the target features allows image quality analyzer 240 to isolate the target areas in order to calculate, from the processed image data, individual image quality metrics 250 that quality analyzer 240 produces as output.

Some earlier examples of automated detection of targets are found in U.S. Pat. No. 5,825,913, “System for finding the orientation of a wafer”; U.S. Pat. No. 5,673,334, “Method and apparatus for inspection of characteristics on non-rigid packages”; U.S. Pat. No. 5,640,200, “Golden template comparison using efficient image registration”; U.S. Pat. No. 5,548,326, “Efficient image registration”; and U.S. Pat. No. 5,500,906 “Locating curvilinear objects using feathered fiducials”.

The values corresponding to individual quality metrics 250 are then compared against acceptable quality values as provided in an image quality profile 270, described in more detail subsequently. This comparison process is done by a quality comparison 260. If all of the quality metrics fall within the range of acceptability defined in the quality profile, an image quality indicator 280 indicates “Pass” status. Otherwise, image quality indicator 280 indicates “Fail”. The “Pass/Fail” status indicator can include a variety of methods and devices, including text messages showing “Pass/Fail”, “OK/Not OK”, or “Good/Bad”, and color-coded symbols or lights (green or red), for example.

For each document page in document queue 110, the processed image data automatically undergoes target recognition, image quality analysis, and quality comparison. For convenience, the combination of target recognition 230, image quality analyzer 240, and quality comparison 260 is denoted as target and quality processor 290, as illustrated in FIG. 2.

After target and quality processor 290 has analyzed the processed image data and compared the quality metrics 250 against the image quality profile 270, a user receives immediate quality feedback from quality indicator 280, such as on a display screen, for example. Moreover, when a processing script is changed in any way, including, for example, the addition/deletion of a step, the order of existing processing steps, and the parameters used in a step, the sequence of operations depicted in FIG. 2 is repeated, so that a user can quickly and efficiently ascertain the impact of the processing script change on the resulting image quality of the processed image data through the feedback from quality indicator 280.

In the preceding discussion, the image quality metrics are calculated only from image quality test target 210. In commonly assigned co-pending U.S. Patent Application No. 2010/0021001 entitled “Method for Making an Assured Image” to Honsinger et al., quality metrics are disclosed that do not depend on a test target and are calculated directly from the image content. The present invention can easily accommodate such “targetless” quality metrics and in a preferred embodiment of this invention, both target-based and targetless metrics are used. The co-pending Honsinger et al. '1001 application also provides a detailed description of different examples of image quality metrics and the targets that could be used to measure such metrics. In one embodiment, the description of the image quality target 210 is achieved by using XML (eXtensible Markup Language) notation. For example, in the preferred embodiment, the physical target dimensions are described in inches. Similarly, the fiducial centers are described in the units of inches and in a coordinate space defined within the physical dimensions of the physical target. Once the fiducials 215 are identified using the automatic target recognition described above, the region or coordinates of the processed scanned image data 180 occupied by the image quality target 210 can be calculated by a simple geometric transformation. By identifying the target area within the scanned image data 180, the area outside of the target can be used to calculate targetless metrics as defined in the co-pending Honsinger et al. '1001 application. Moreover, it is possible to calculate only targetless quality metrics for scanned image data that does not include a test target anywhere within the image.

It is worthwhile to note that when only target-based quality metrics are used, it is possible to apply image processing only to the detected target region and still compute the necessary quality metrics. The benefit of such an approach is that processing time can be reduced (because the target typically makes up only a fraction of the total image data), thus giving a user more rapid feedback on the image quality when a number of different image processing scripts are being evaluated. Once a desired level of quality has been achieved with a particular processing script, the entire body of scanned image data can be processed with that script to produce the processed image data.

Still referring to the processes shown in FIG. 2, image quality analyzer 240 and quality comparison 260 can execute after each operation step specified in image processing script 150 to update image quality indicator 280 on an on-going basis. Although this requires added computation time, it provides image quality feedback to the operator following each processing step.

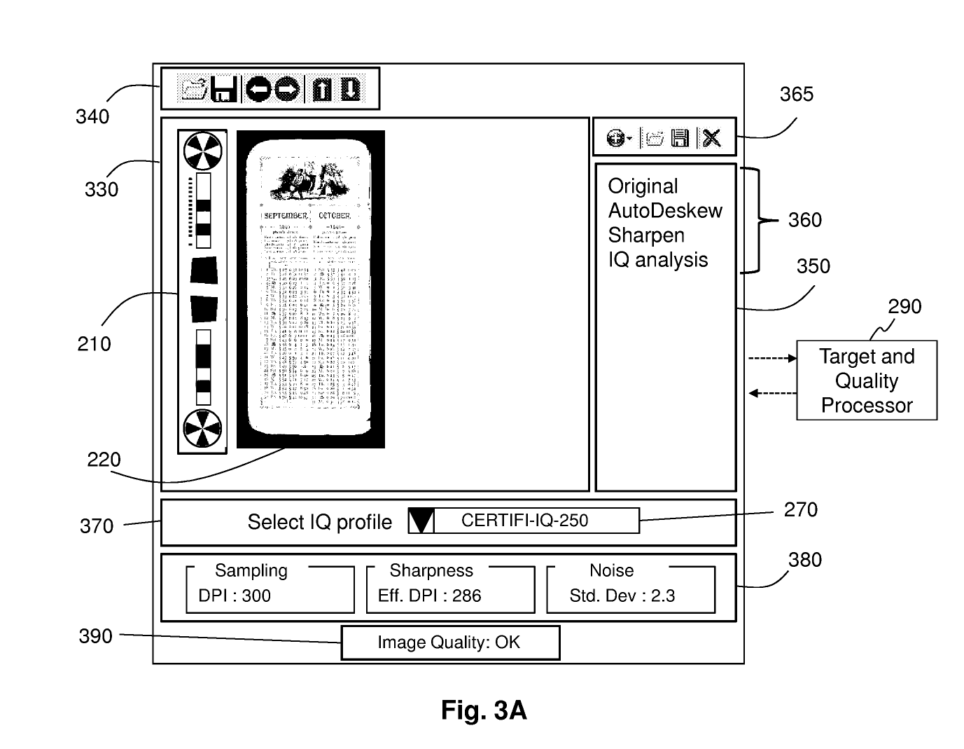

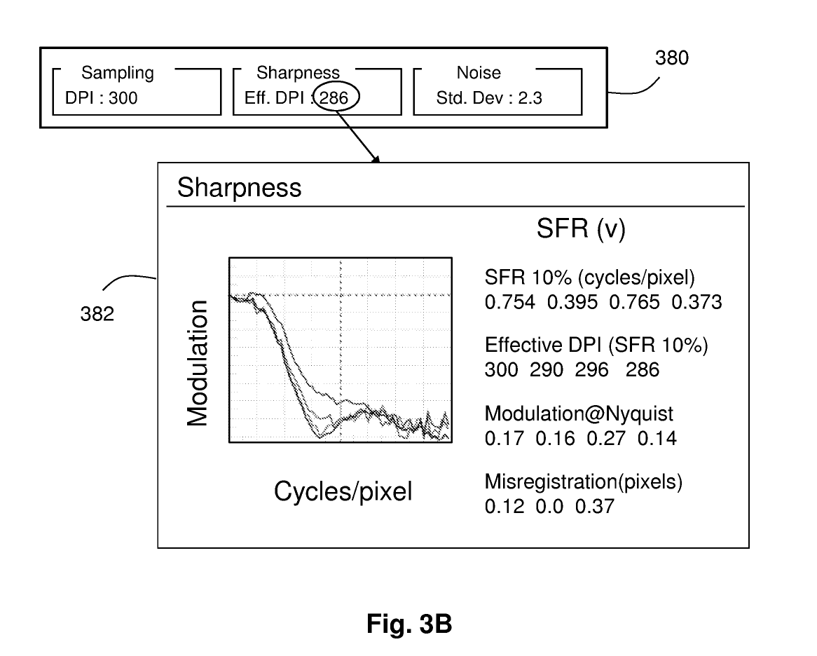

Referring now to FIG. 3A, an example of a software application of the present invention is illustrated. The software application allows the user to try different image processing steps and to see the effect on overall image quality through the use of a quality indicator. Additionally, it allows the user to see the effect of the different image processing steps on individual image quality metrics that relate to the overall image quality. Furthermore, it allows a user to evaluate the image quality metrics against different quality profiles to see if the processed image data is suitable for different applications. This example software application encompasses processing and feedback elements that were shown in FIG. 2 for carrying out the present invention, including image processor 170, target and quality processor 290, and image quality indicator 280.

In FIG. 3A, the scanned image data 150 again comprises an image quality test target 210 and an example page 220 from a 19^{th} century Farmer's Almanac page, and the image data is shown in an image display window 330. If a plurality of images is available, image display navigation tools 340 allow the user to move between different images as well.

An image processing script window 350 is provided as a place to see a list of the elements 360 that comprise the image processing script. The state of image processing script elements 360 is entirely equivalent to image processing script 160.

In FIG. 3A, “AutoDeskew” and “Sharpen” are shown as image processing script elements 360. The other script elements “Original” and “ImageQualityAnalysis” are fixed placeholders to allow a user to display the original (scanned) image data 150 prior to image processing and to indicate that the quality analysis is performed at the end of image processing. Individual processing elements may be added, deleted, and/or moved using image processing script editor tools 365. With each change to the processing script, target and quality processor 290 analyzes the processed image data to update the status of the image quality indicator. The image processing script editor tools also allow the user to read in an existing image processing script or to save the image processing script elements 360 to a file to produce a new image processing script. Saving a processing script allows it to be used as needed in high-volume scanning workflows as depicted previously in FIG. 1.

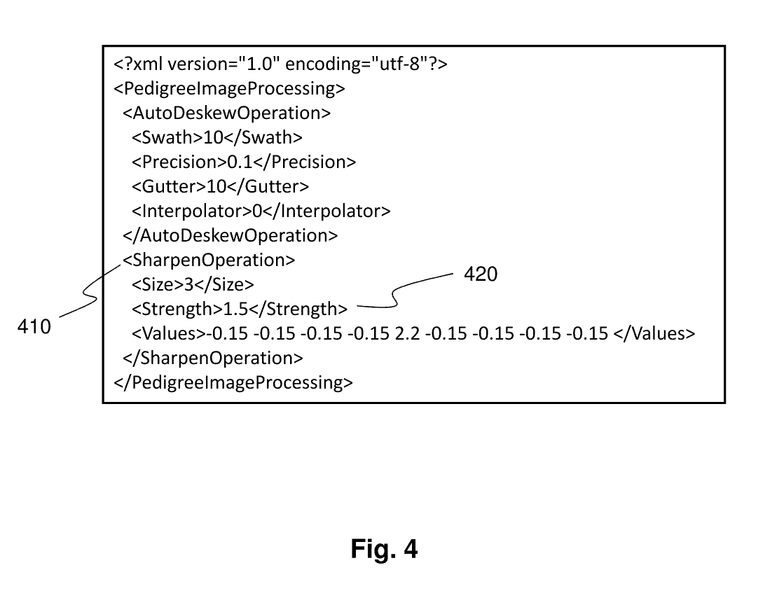

In one embodiment, image processing script 160 is represented as an XML (eXtensible Markup Language) file. An XML representation provides a convenient and easy way to port image processing scripts over different platforms and different applications. FIG. 4 depicts an example of an image processing script in XML. Reading an XML file is straightforward; for example, “SharpenOperation” 410 instructs image processor 170 to sharpen the scanned image data 150 with a sharpening strength 420 equal to 1.5 (i.e., <Strength>1.5<\Strength>). Other example image processing operations and their associated parameters are also shown in FIG. 4.

Referring again to FIG. 3A, image quality profile 270 is loaded into the application by using image quality profile selection interface 370. In this example, the image quality profile labeled “Certifi-IQ-250” has been selected.

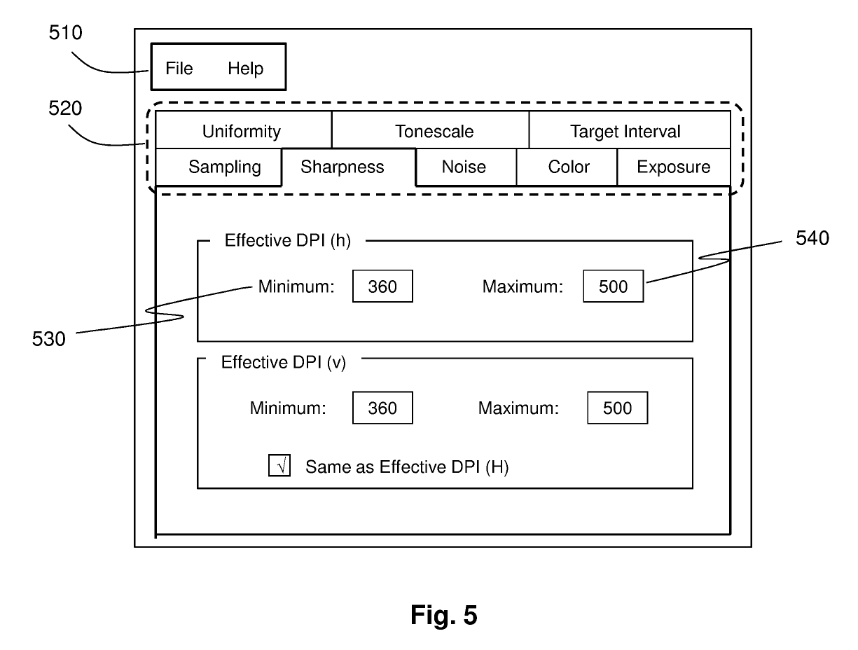

To manage image quality profiles, an image quality profile editor can be used. FIG. 5 depicts an example software application that serves as an image profile editor. An existing image quality profile can be read into the image quality profile editor by using image quality profile “input-output” tools 510. Similarly, a newly created or edited image quality profile can be saved using the image quality profile “input-output” tools 510. Each image quality attribute can be selected by activating one of the metric attribute tabs 520. In FIG. 5, the sharpness attribute has been selected within the metric attribute tabs 520. In this example, the sharpness attribute is measured by quality metric called “effective DPI”. In FIG. 5, the minimum effective DPI (h) 530 has a value of 360 and the maximum effective DPI (h) 540 has a value of 500. The (h) designates that the metric is measured in the horizontal direction within the processed image data.

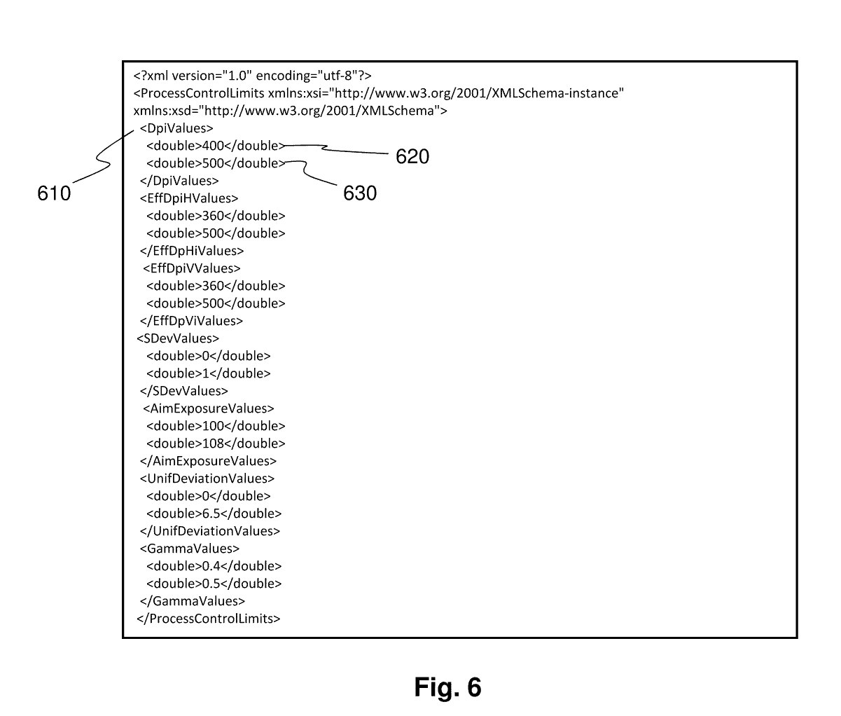

Each quality requirement can be represented as a set of lower and upper limits for the individual image quality metric. Combined sets of lower and upper limits that contain one or more quality requirements form an image quality profile. If a user scans image data for multiple purposes, for example, there may be a variety of different image quality profiles in use at a particular scanning site. In one embodiment, an image quality profile is represented as an XML file. FIG. 6 depicts an example image quality profile expressed in XML. The XML representation includes image quality metric names, followed by their lower and upper limits. For example, the metric associated with DPI (Dots Per Inch) has “DpiValues” 610 that include a minimum acceptable DPI 620 with a value of 400 and a maximum acceptable DPI 630 with a value of 500.

Referring once again to FIG. 3A, a set of image quality indicators 380 is displayed in response to parameter changes in the image processing script elements 360. These quality indicators represent the state of individual quality metrics when compared against the corresponding limits in the quality profile. In one embodiment, individual image quality indicators within the set of quality indicators 380 are presented in red or are highlighted in some other color when the quality metric value falls outside of the bounds set in the image quality profile; these values display in green if the value falls inside the bounds set in the image quality profile. By providing this type of feedback, a user can more quickly identify and address any quality problems with an appropriate image processing function. For example, if the calculated noise exceeds the image quality profile maximum for noise, a user can add an image processing script element to perform noise cleaning. The noise cleaning process will reduce the noise and potentially process the image so that all image quality metrics are now within the acceptable image quality profile bounds.

A further reporting capability is shown in the example of FIG. 3B. By clicking or providing some other operator command relative to one of quality indicators 380, the operator can obtain a quality detail window 382 with additional information related to a particular image quality indicator, such as a graph as shown.

It should be noted that there is always a tradeoff in addressing image quality deficiencies with image processing functions. If a noise cleaning process is added to the image processing script elements 360 to address the excessive noise discussed above with reference to FIG. 3A, it is known to those skilled in the art that the sharpness will consequently decrease in the image. Fortunately, embodiments of the present invention can considerably reduce the amount of time needed to determine the proper amount of noise cleaning to keep the image quality within specifications. This is because, once the user adds a noise cleaning step to the image processing script, its effect can be immediately displayed and reported with respect to the quality metrics associated with the selected image quality profile through the feedback provided by the set of image quality indicators 380.

Many scanner operators or users may not have the sophistication to independently make a change in the image processing script to address a deficiency in the image quality. For such users, it can be preferable to have a single image quality indicator reflecting whether or not a processed image meets all of the quality requirements defined by the image quality profile. As depicted in FIG. 3A, the overall pass/fail image quality indicator 390 is simply presented as a text field indicating whether or not all quality metrics are within the limits represented by the image quality profile. When the image quality meets the all requirements defined by the image quality profile, the indicator text field shows “OK” or indicates acceptable image quality (pass status) and when the image quality does not meet all requirements, the indicator text field is presented as “Not OK” or otherwise indicates fail status. Clearly, there are multiple embodiments for enabling the image quality indicator, either as a set of individual quality indicators or as a single overall image quality indicator.

In one embodiment, using the operator interface of FIG. 3A, an operator menu selection specifies each image processing step and allows selection and editing of suitable parameters. As each image processing step is executed, the software evaluates the processed scanned image data according to the one or more image quality requirement values obtained from the predetermined image quality profile. Evaluation result data is generated and can be displayed for viewing by the operator. In addition, the display of the scanned image, as shown at image display window 330 in FIG. 3A, is refreshed according to the results of the image processing operation that was just executed. This process can repeat multiple times, such as with each page of a multi-page document, for example.

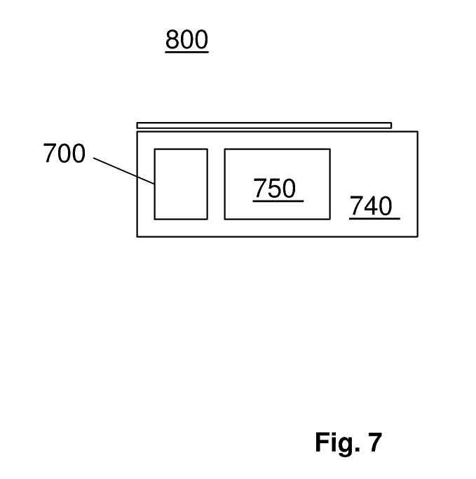

In an alternate integrated embodiment, scanner 130 can contain within itself computer 140, scanned image data 150, image processor 170, and processed image data 180. Image processing script 160 can be downloaded to scanner 130 via an Internet or other network connection, for example, or the script (or scripts) can be preloaded into scanner memory. Processed image data 180 can then be output from the integrated embodiment of scanner 130 to storage 190. This integrated embodiment can be realized using modern day scanning and computer technologies. FIG. 7 shows an integrated scanning system 800 that includes a scanner apparatus 740, a control logic processor 750 and a display 700, all integrated into one compact system, within a single equipment chassis. Display 700 can be a touch screen display, for example.

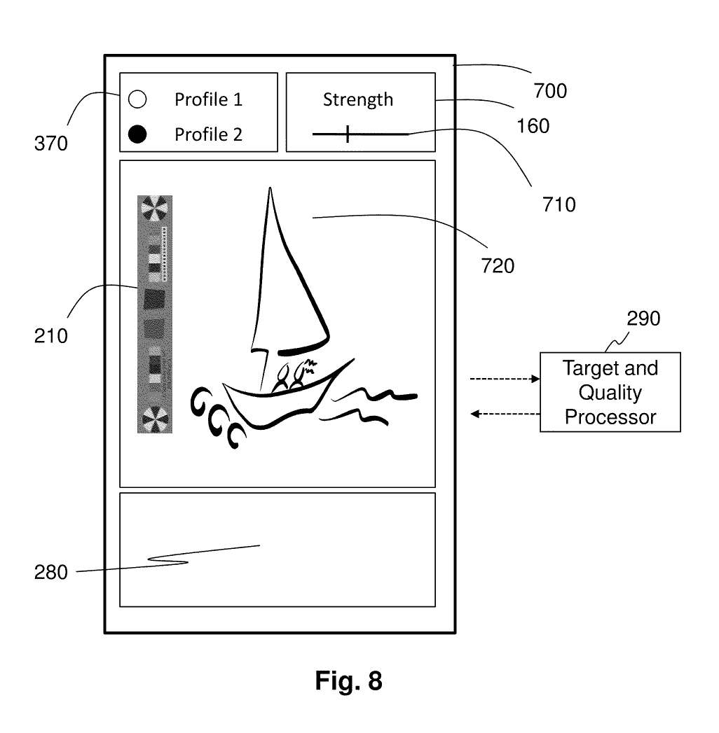

An example LCD screen, display 700, appearing on the scanner is depicted in FIG. 8. For sake of simplicity and clarity, assume that the LCD is a touch screen and that image quality profiles are already loaded into the scanner's integrated computer. Such an integrated computer can is considered to be part of the scanner itself, with control logic functions integrated in firmware, having programmed instructions that configure the scanner to execute commands according to the present invention, forming an integrated computer thereby. The image quality profiles can be loaded wirelessly from an external computing station, preloaded at the factory, loaded from removable data storage media, or obtained using any networking device as examples. The image quality profile 270 is touch-selectable by touching either “Profile 1” or “Profile 2” in image quality profile selection interface 370, and the image processing script 160 (in this case only sharpening is presented) is selectable by touching a trackbar 710 and choosing a sharpening strength.

In response to a change in the sharpening strength, target and quality processor 290 is run on image quality test target 210 and sailboat image 720 in an identical fashion as in the previously described embodiment. If all of the measured quality metrics fall within the range of acceptability defined by the selected quality profile, a green LED light is displayed to provide image quality indicator 280. Otherwise, a red LED light is displayed as image quality indicator 280. If the quality is indicated as being unacceptable, a user could then take various actions, such as rescanning and/or changing the sharpening strength. Among its advantages, this alternative embodiment allows changes to scanning conditions to be discerned and rectified at the scanner itself, allowing for changes in the scanner acquisition parameters rather than relying on post scanning correction. In general, it is advantageous to acquire scans with the preferred set of parameters rather than relying on post scan processing.

The invention has been described in detail with particular reference to certain preferred embodiments thereof, but it will be understood that variations and modifications can be effected within the spirit and scope of the invention.

### PARTS LIST

110 document queue

120 current document

130 scanner

140 computer

150 scanned image data

160 image processing script

170 image processor

180 processed image data

190 storage

210 image quality test target

215 example fiducials

220 example page from a 19th century Farmer's Almanac

230 target recognition

240 image quality analyzer

250 image quality metrics

260 quality comparison

270 image quality profile

280 image quality indicator

290 target and quality processor

330 image display window

340 image display navigation tools

350 image processing script window

360 image processing script elements

365 image processing script editor tools

370 image quality profile selection interface

380 set of image quality indicators

382 quality detail window

390 pass/fail image quality indicator

410 “SharpenOperation”

420 sharpening strength

510 image quality profile “input-output” tools

520 metric attribute tabs

530 minimum effective DPI (h)

540 maximum effective DPI (h)

610 “DpiValues”

620 minimum acceptable DPI

630 maximum acceptable DPI

700 display

710 sharpness strength trackbar

720 sailboat image

740 scanner apparatus

750 control logic processor

800 scanning system

1. A method for processing scanned image data, executed at least in part by a computer system, the method comprising
a) obtaining scanned image data;
b) obtaining a predetermined image quality profile that comprises one or more image quality requirement values;
c) generating processed image data by applying one or more image processing operations to the image data in accordance with a processing script;
d) calculating image quality metrics from the processed image data;
e) comparing the calculated image quality metrics to the one or more image quality requirement values from the predetermined quality profile; and
f) displaying results of the image quality comparison.

2. The method of claim 1 further comprising selecting the processing script from a set of stored processing scripts.

3. The method of claim 1 further comprising applying an additional image processing operation to the image data and repeating steps d) through f).

4. The method of claim 1 further comprising identifying a target from the scanned image data.

5. The method of claim 4 wherein calculating image quality metrics comprises using processed image data from the identified target.

6. The method of claim 1 wherein the scanned image data does not include a target.

7. The method of claim 1 wherein the one or more image processing operations includes at least one of a brightness adjustment, a contrast adjustment, a cropping operation, a de-skewing operation, imaging sharpening, optical character recognition, geometric distortion removal, image compression, nonlinear enhancement, object detection, smoothing, gamma correction, despeckle, blur, grayscale conversion, white balance adjustment, bordering, cropping, and noise cleaning.

8. The method of claim 1 wherein the one or more image quality requirement values include values taken from the group consisting of an exposure aim value, a sharpness value, a gamma value, a noise value, a clipping value, and a uniformity deviation value.

9. The method of claim 1 wherein the comparison results indicate only one of either pass or fail status.

10. The method of claim 1 wherein the scanned image data comprises data from an image quality target.

11. The method of claim 1 further comprising displaying additional quality result data in response to an operator command entry.

12. A method for operating a scanner system, comprising:
displaying a graphical user interface on a display screen, wherein the graphical user interface comprises:
(i) an image display window that displays image data;
(ii) an image quality profile selector that enables and displays an operator selection of an image quality profile comprising one or more image quality requirement values for evaluation of the image data;
(iii) an image processing selector that enables operator selection and execution of image processing steps for the image data and displays the selected image processing steps;
(iv) one or more image quality indicators that indicate results of a quality evaluation according to the operator selection of the image quality profile;
refreshing the one or more image quality indicators following execution of each image processing step; and
refreshing the image display with processed image data following execution of each image processing step.

13. The method of claim 12 wherein the one or more image quality indicators comprise a pass or fail indicator.

14. An apparatus for scanning an image comprising:
a) a scanner apparatus that acquires scanned image data from an original;
b) a control logic processor in data communication with the scanner apparatus and energizable to execute a set of programmed instructions for obtaining and processing the scanned image data; and
c) a display in data communication with the control logic processor and providing at least an image display window for display of the scanned image data, a profile selection window for operator selection of an image quality profile, and an indicator for reporting image quality in accordance with the operator selection of the image quality profile.

15. The apparatus of claim 14 wherein the scanner apparatus, control logic processor, and display are provided within a single equipment chassis.

16. The apparatus of claim 14 wherein the display is a touch screen display.
